(19) United States
(12) Patent Application Publication
(10) Pub. No.: US 2013/0003236 A1
(43) Pub. Date: Jan. 3, 2013

(54) POWER SUPPLY CIRCUIT

(75) Inventors: XIAO-ZHAN PENG, Shenzhen City (CN); XUE-BING DENG, Shenzhen City (CN); HSING-SUANG KAO, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/212,195

(22) Filed: Aug. 18, 2011

(30) Foreign Application Priority Data
Jun. 28, 2011 (CN) 201110176611.8

(51) Int. Cl. H02H 9/04

(52) U.S. Cl. 361/56

(57) ABSTRACT

A power supply circuit for providing over-voltage protection includes a power supply unit and an output. The power supply unit includes a power input control terminal and a power output terminal. The power output terminal configured for connection to the output for supplying power to a load connected to the output. The power supply circuit includes an over-voltage response unit for connection to the output, and a control unit. The control unit is connected between the over-voltage response unit and the power input control terminal. The over-voltage response unit is configured for turning on the control unit. The control unit is configured for transmitting a control signal to the power supply unit to control the power supply unit to stop outputting power when it is turned on.

### BACKGROUND

1. Technical Field

The present disclosure relates to power supply circuits, and particularly to, a power supply circuit providing over-voltage protection.

2. Description of Related Art

Power supply circuits of electronic devices may include a zener diode connected to an output of a power supply of the electronic device for regulating the voltage of the output. Thus the voltage of a load connected to the output of the electronic device is maintained within a rated voltage of the load to protect the load from being damaged. However, although the load may be protected, an over-voltage condition could still occur with the electronic device and possibly damage electronic components and/or the power supply of the electronic device.

Therefore, what is needed is a power supply circuit able to alleviate the limitations described above.

### BRIEF DESCRIPTION OF THE DRAWINGS

The components in the drawings are not necessarily drawn to scale, the emphasis instead being placed upon clearly illustrating the principles of a power supply circuit capable of over-voltage protection. Moreover, in the drawings, like reference numerals designate corresponding sections throughout the several views.

FIG. 1 is a block diagram of a system with a power supply circuit in accordance with an exemplary embodiment.

FIG. 2 is a circuit diagram of the system with the power supply circuit of FIG. 1.

### DETAILED DESCRIPTION

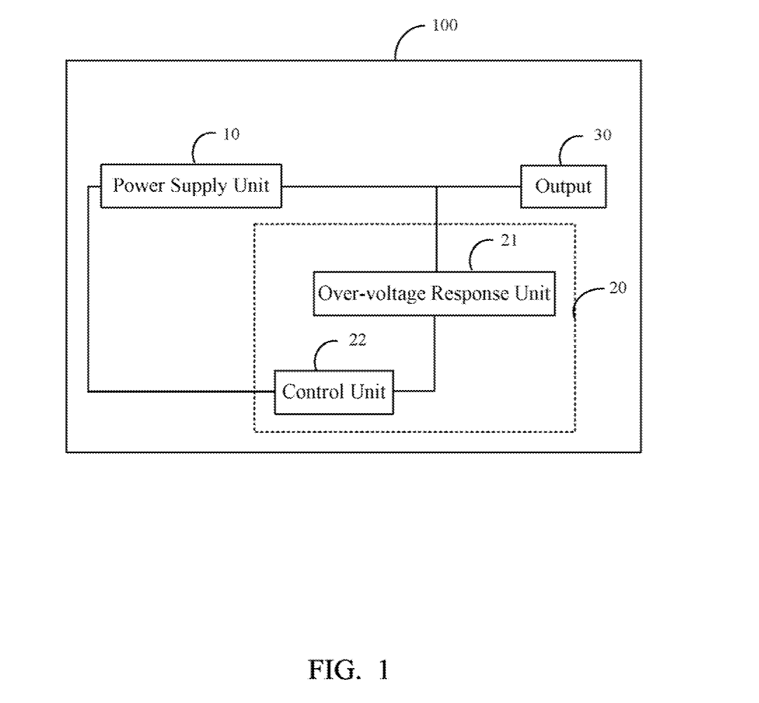

Referring to FIG. 1, a block diagram of a system with a power supply circuit in accordance with an exemplary embodiment is disclosed. The system 100 includes a power supply unit 10, a power supply circuit 20, an output 30 connected to the power supply unit 10 and the power supply circuit 20. The output 30 is configured for connecting to a load (not shown). The power supply unit 10 includes a power input control terminal Vin, and a power output terminal Vout. The power supply unit 10 supplies power to the load via the power output terminal Vout connecting to the output 30. The power supply circuit 20 is configured to protect the load and the power supply unit 10 from over-voltage. In the embodiment, the power supply unit 10 is a power chip or a power adaptor.

The power circuit 20 includes an over-voltage response unit 21 and a control unit 22. The over-voltage response unit 21 is connected to the power output terminal Vout. The over-voltage response unit 21 is also connected to the control unit 22. The over-voltage response unit 21 is configured for turning on the control unit 22 when the voltage of the output 30 exceeds a maximum rated voltage.

The control unit 22 is connected between the over-voltage response unit 21 and the power input control terminal Vin. The control unit 22 is configured for transmitting a control signal to the power input control terminal Vin when turned on. The voltage of the power input control terminal Vin is then lowered to control the power supply unit 10 to power itself off. Thus, the power output terminal Vout cannot output power to the output 30 and further to the load. In the embodiment, the over-voltage response unit 21 controls the control unit 22 to be off when the voltage of the output 30 is less than or equal to the maximum rated voltage. The over-voltage response unit 21 turns on the control unit 22 only when the voltage of the output 30 exceeds the maximum rated voltage, and the control unit 22 is needed to provide protection.

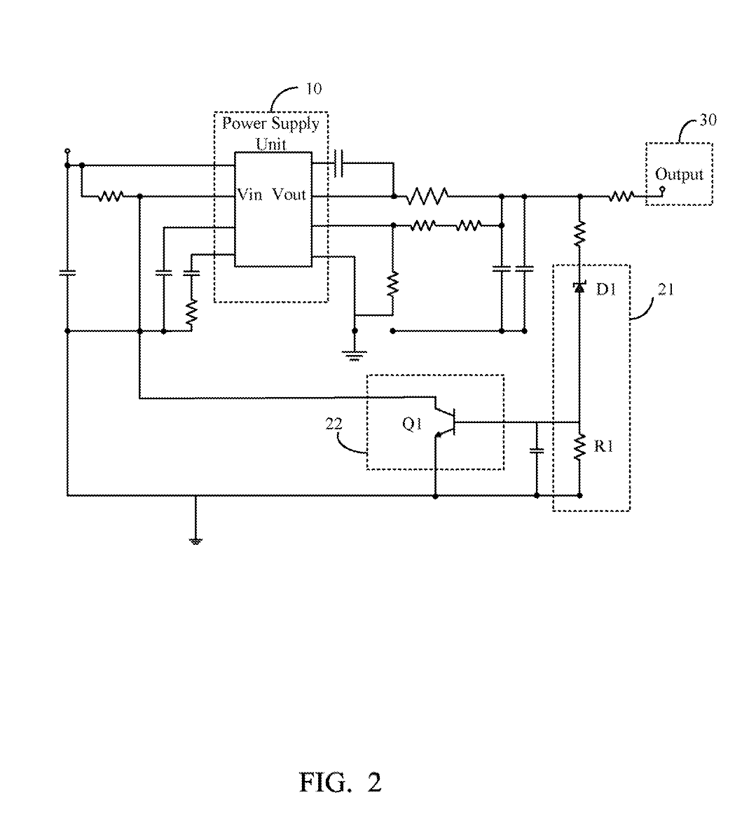

Referring to FIG. 2, a circuit diagram of the system 100 with the power supply circuit 20 is provided as an embodiment. The over-voltage response unit 21 includes a zener diode D1 and a resistance element R1 connected between the output 30 and ground in series. A node between the resistance element R1 and the zener diode D1 is connected to the control unit 22. In the embodiment, the voltage of the zener diode D1 is equal to the breakdown voltage thereof, when the voltage of the output 30 exceeds the maximum rated voltage. That is, the breakdown voltage of the zener diode D1 is predetermined according to the maximum rated voltage of the output 30. The zener diode D1 is conducted when the voltage of the output 30 exceeds the maximum rated voltage.

The control unit 22 includes an npn transistor Q1. In the embodiment, the emitter of the npn transistor Q1 is grounded, the base of the npn transistor Q1 is connected to the terminal connected to a node formed between the resistance element R1 and the zener diode D1, and the collector of the npn transistor Q1 connects to the power input control terminal Vin. When the zener diode D1 is conducted, the current flows through the resistance element R1 and a voltage drop occurs across the resistance element R1. The voltage drop is used to turn on the npn transistor Q1. The power input control terminal Vin thus receives a low voltage control signal. The power supply unit 10 stops outputting power upon receiving the low voltage control signal. The power supply of the power output terminal Vout is cut off. In an alternative embodiment, the npn transistor Q1 can be replaced by an NMOS transistor.

With such configuration, when the voltage of the output 30 exceeds the maximum rated voltage, the power supply circuit 20 transmits a low voltage control signal to the power supply unit 10 to power off the power supply unit 10. Thus the load connected to the output 30, the electronic components of the power supply circuit 20, and the power supply unit 10 are all protected from being damaged by over-voltage.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A power supply circuit for providing over-voltage protection for a power supply unit and an output, the power supply unit comprising a power input control terminal and a power output terminal, the power output terminal configured for connection to the output for supplying power to a load connected to the output, the power supply circuit comprising:
an over-voltage response unit for connection to the output; and
a control unit connected between the over-voltage response unit and the power input control terminal;
wherein the over-voltage response unit is configured for turning on the control unit, and the control unit is configured for transmitting a control signal to the power supply unit to control the power supply unit to stop outputting power when turned on.

2. The power supply circuit as described in claim 1, wherein the over-voltage response unit comprises a zener diode and a resistance element connected between the output and ground in series.

3. The power supply circuit as described in claim 1, wherein the control unit comprises an npn transistor.

4. The power supply circuit as described in claim 3, wherein the emitter of the npn transistor is grounded, the base of the npn transistor is connected to a node formed between the resistance element and the zener diode, and the collector of the npn transistor is connected to the power input control terminal.

5. The power supply circuit as described in claim 4, wherein the voltage across the zener diode is equal to a breakdown voltage thereof when the voltage of the output exceeds the maximum rated voltage, the current flows through the resistance element and a voltage drop occurs across the resistance element, the voltage drop is used to turn on the npn transistor.

6. The power supply circuit as described in claim 5, wherein when the power input control terminal receives a low voltage control signal, the power supply unit is configured to stop outputting power upon receiving the low voltage control signal.
